(19) United States
(12) Patent Application Publication
(10) Pub. No.: US 2025/0284071 A1
(43) Pub. Date: Sep. 11, 2025

(54) OPTICAL PORT/CONNECTOR MAGNETIC SECURING/RELEASE SYSTEM

(71) Applicant: Dell Products L.P., Round Rock, TX (US)

(72) Inventors: Victor Teeter, Round Rock, TX (US); Shree RamaKrishna Rathinasamy, Georgetown, TX (US); Neal Beard, Austin, TX (US)

(21) Appl. No.: 18/599,326

(22) Filed: Mar. 8, 2024

(51) Int. Cl. G02B 6/38

(52) U.S. Cl. CPC G02B 6/3886

(57) ABSTRACT

An optical cable system includes an optical cable and an optical connector that is included on the optical cable. A connector magnetic securing subsystem is included on the optical connector and is configured to magnetically connect to a port magnetic securing subsystem on an optical port to secure the optical connector to an optical port. A mechanical release device is coupled to the optical connector and is configured to mechanically disconnect the connector magnetic securing subsystem from the port magnetic securing subsystem to release the optical connector from the optical port.

### BACKGROUND

The present disclosure relates generally to information handling systems, and more particularly to magnetically securing and releasing an optical connector to and from an optical port on an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, switch devices, other networking devices, storage systems, server devices, and/or other computing devices known in the art, sometimes utilize optical data transmission systems in order to transmit data. For example, switch devices often utilize fiber optic ports (e.g., fiber optic ports integrated with the switch device, fiber optic ports provided on fiber optic transceiver systems coupled to the switch device, etc.) in order to optically transmit data via fiber optic cables connected to those fiber optic ports via fiber optic connectors. However, the conventional securing of such fiber optic connectors to fiber optic ports can raise some issues.

For example, conventional fiber optic cables may utilize Lucent Connectors (LCs) including a plastic housing with a latch that enables “push/pull” functionality with a corresponding fiber optic port, Standard Connectors (SCs) that are similar to LCs but include a locking tab in place of the latch, Ferrule Core (FC) connectors that are threaded to screw on to a corresponding fiber optic port, Straight Tip (ST) connectors that are similar to FC connectors but that replace the threads with a locking mechanism provided by a plug and a socket that are locked by a half-twist bayonet lock, Multi-fiber Push-On (MPO) connectors used to connect ribbon cables with multiple fibers to a corresponding fiber optic port, as well as other conventional fiber optic connectors known in the art.

As will be appreciated by one of skill in the art, such conventional fiber optic connectors include a relatively high number of components that can increase their cost, and many of which move relative to each other and that cause wear that requires their replacement over time. One example of such components are those included in the conventional alignment mechanisms that are used with conventional fiber optic connectors to ensure they are oriented correctly with respect to an fiber optic port in order to operate properly, and those conventional alignment mechanisms suffer from additional issues as they often make it difficult to properly align those fiber optic connectors for engagement with corresponding fiber optic ports, while requiring careful attention so as to not damage the fiber optic connector or the fiber optic port.

Accordingly, it would be desirable to provide a fiber optic port/connector securing/release system that addresses the issues discussed above.

### SUMMARY

According to one embodiment, an Information Handling System (IHS) includes a chassis; a processing system that is housed in the chassis; an optical port that is included on the chassis and that is coupled to the processing system; a port magnetic securing subsystem that is included on the optical port; an optical cable; an optical connector that is included on the optical cable; a connector magnetic securing subsystem that is included on the optical connector and that is magnetically connected to the port magnetic securing subsystem to secure the optical connector to the optical port; and a mechanical release device that is coupled to the optical connector and that is configured to mechanically disconnect the connector magnetic securing subsystem from the port magnetic securing subsystem to release the optical connector from the optical port.

### BRIEF DESCRIPTION OF THE DRAWINGS

FIG. 1 is a schematic view illustrating an embodiment of an Information Handling System (IHS).

FIG. 2 is a schematic view illustrating an embodiment of an optical cable system that may be provided according to the teachings of the present disclosure.

FIG. 3A is a schematic view illustrating an embodiment of an optical connector that may be included on the optical cable system of FIG. 2.

FIG. 3B is a schematic view illustrating an embodiment of an optical connector that may be included on the optical cable system of FIG. 2.

FIG. 4A is a perspective view illustrating an embodiment of the optical cable system of FIG. 2 with its mechanical release device in a securing orientation.

FIG. 4B is a side view illustrating an embodiment of the optical cable system of FIG. 2 with its mechanical release device in a securing orientation.

FIG. 4C is a side view illustrating an embodiment of the optical cable system of FIG. 2 with its mechanical release device in a release orientation.

FIG. 5 is a schematic view illustrating an embodiment of an optical transceiver system that may be used with the optical cable system of FIG. 2.

FIG. 6 is a schematic view illustrating an embodiment of a computing device that may be used with the optical cable system of FIG. 2.

FIG. 7A is a schematic view illustrating an embodiment of an optical port that may be included on the optical transceiver system of FIG. 5 or the computing device of FIG. 6.

FIG. 7B is a schematic view illustrating an embodiment of an optical port that may be included on the optical transceiver system of FIG. 5 or the computing device of FIG. 6.

FIG. 8 is a flow chart illustrating an embodiment of a method for magnetically securing and releasing an optical connector to and from an optical port.

FIG. 9A is a schematic view illustrating an embodiment of an optical connector on the optical cable system of FIGS. 4A-4C being moved adjacent the optical transceiver system of FIG. 5 while oriented with an optical port on the optical transceiver system.

FIG. 9B is a schematic view illustrating an embodiment of the optical connector on the optical cable system of FIGS. 4A-4C magnetically interacting with the optical port on the optical transceiver system of FIG. 5.

FIG. 9C is a schematic view illustrating an embodiment of the optical cable system of FIGS. 4A-4C connected to the optical transceiver system of FIG. 5.

FIG. 10A is a schematic view illustrating an embodiment of the optical cable system of FIGS. 4A-4C being connected to the computing device of FIG. 6.

FIG. 10B is a schematic view illustrating an embodiment of an optical connector on the optical cable system of FIGS. 4A-4C magnetically interacting with an optical port on the computing device of FIG. 6.

FIG. 10C is a schematic view illustrating an embodiment of the optical cable system of FIGS. 4A-4C connected to the computing device of FIG. 6.

FIG. 11A is a schematic view illustrating an embodiment of an optical connector on the optical cable system of FIGS. 4A-4C being moved adjacent the optical transceiver system of FIG. 5 while misoriented with an optical port on the optical transceiver system.

FIG. 11B is a schematic view illustrating an embodiment of the optical cable system of FIGS. 4A-4C being prevented from being connected to the optical transceiver system of FIG. 5 when the optical connector on the optical cable system is misoriented with the optical port on the optical transceiver system.

FIG. 12A is a schematic view illustrating an embodiment of an optical connector on the optical cable system of FIGS. 4A-4C being moved adjacent the computing device of FIG. 6 while misoriented with an optical port on the computing device.

FIG. 12B is a schematic view illustrating an embodiment of the optical cable system of FIGS. 4A-4C being prevented from being connected to the computing device of FIG. 6 when the optical connector on the optical cable system is misoriented with the optical port on the computing device.

FIG. 13A is a schematic view illustrating an embodiment of the optical cable system of FIGS. 4A-4C being disconnected from the optical transceiver system of FIG. 5.

FIG. 13B is a schematic view illustrating an embodiment of the optical cable system of FIGS. 4A-4C disconnected from the optical transceiver system of FIG. 5.

FIG. 13C is a schematic view illustrating an embodiment of the optical cable system of FIGS. 4A-4C disconnected from the optical transceiver system of FIG. 5.

FIG. 14A is a schematic view illustrating an embodiment of the optical cable system of FIGS. 4A-4C being disconnected from the computing device of FIG. 6.

FIG. 14B is a schematic view illustrating an embodiment of the optical cable system of FIGS. 4A-4C disconnected from the computing device of FIG. 6.

FIG. 14C is a schematic view illustrating an embodiment of the optical cable system of FIGS. 4A-4C disconnected from the computing device of FIG. 6.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

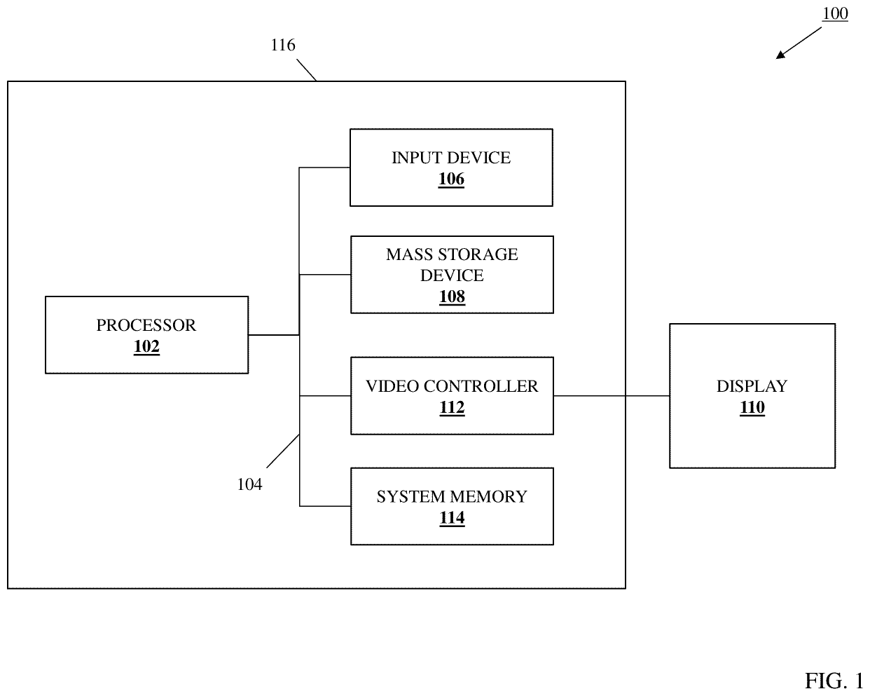

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

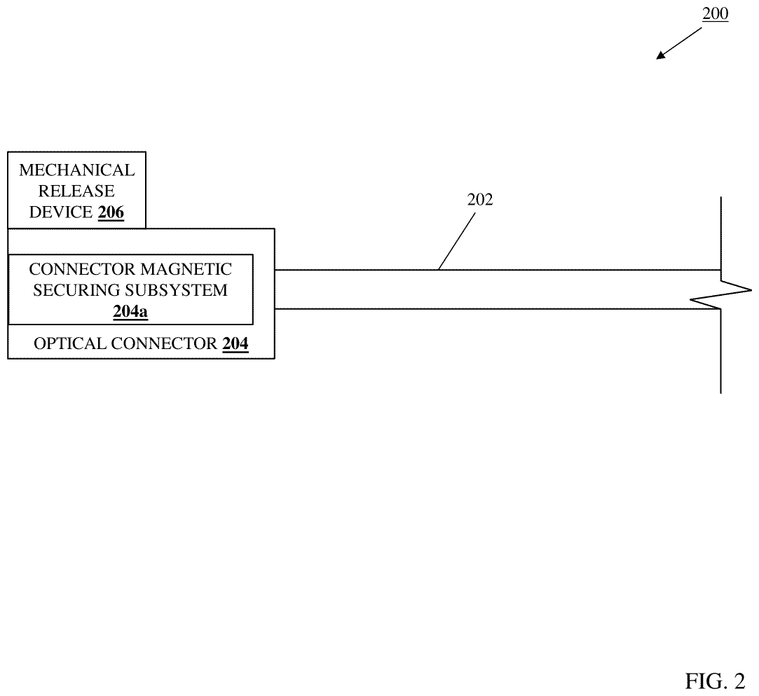

Referring now to FIG. 2, an embodiment of an optical cable system 200 is illustrated that may be provided according to the teachings of the present disclosure. In the illustrated embodiment, the optical cable system 200 includes an optical cable 202 that one of skill in the art in possession of the present disclosure will appreciate may be provided by any of a variety of fiber optic cables known in the art. As illustrated, an optical connector 204 is included on an end of the optical cable 202, and one of skill in the art in possession of the present disclosure will appreciate how at least one optical connector (and a plurality of optical connectors in the case of a “breakout” type cable) may be provided on opposing, unillustrated ends of the optical cable 202 while remaining within the scope of the present disclosure as well. As illustrated, a connector magnetic securing subsystem 204a is included on the optical connector 204, and as described below may be configured in a variety of manners to secure the optical connector 204 to an optical port. Furthermore, a mechanical release device 206 is included on the optical connector 204, and as described below may be configured in a variety of manners to mechanically disconnect the connector magnetic securing subsystem 204a from an optical port to which it is connected in order to release the optical connector 204 from the optical port. However, while some specific examples of the connector magnetic securing subsystem 204a and the mechanical release device 206 are provided below, one of skill in the art in possession of the present disclosure will appreciate how the connector magnetic securing subsystem and the mechanical release device of the present disclosure may be configured in a variety of manners in order to provide the functionality described below.

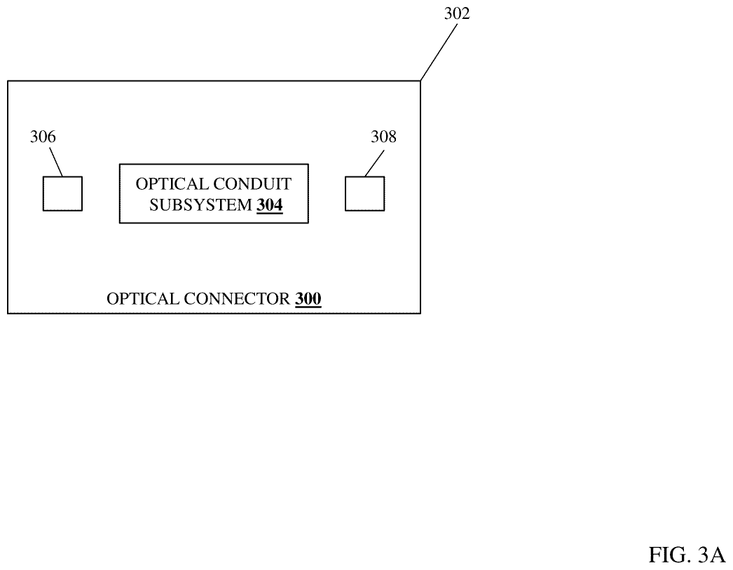

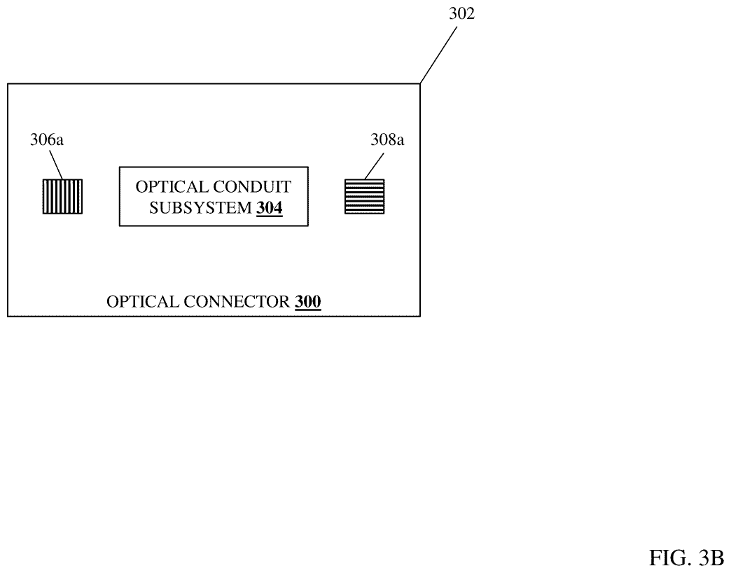

With reference to FIG. 3A, an embodiment of an optical connector 300 is illustrated that may provide the optical connector 204 discussed above with reference to FIG. 2, but with the mechanical release device 206 omitted for clarity. In the illustrated embodiment, the optical connector 300 includes a base 302 having an optical conduit subsystem 304 that one of skill in the art in possession of the present disclosure will appreciate may include fiber ferrule(s) (e.g., which are coupled to optical fibers in an attached optical cable) and/or other fiber optic components known in the art. As will be appreciated by one of skill in the art in possession of the present disclosure, the base 302 and the optical conduit subsystem 304 of the optical connector 300 may be similar to the base and optical conduit subsystem included on conventional fiber optic connectors (e.g., the LCs, SCs, FC connectors, ST connectors, and MPO connectors discussed above, as well as other fiber optic connectors known in the art), but with the optical port alignment and connection components on those conventional fiber optic connectors replaced by the optical port alignment and connection components described below. Furthermore, one of skill in the art in possession of the present disclosure will appreciate how the optical connectors of the present disclosure eliminate many components utilized in the conventional optical connectors referenced above (e.g., alignment components, latches/pull tabs used to disconnect conventional optical connectors from their optical port, etc.), thus reducing material costs, manufacturing costs, points of failure, and overall complexity.

As illustrated, the base 302 of the optical connector 300 may include a connector magnetic securing subsystem that provides the connector magnetic securing subsystem 204a on the optical connector 204 discussed above with reference to FIG. 2. In the examples illustrated and described below, the connector magnetic securing subsystem on the optical connector 300 includes a pair of magnets 306 and 308 that are located on the base 302 on opposite sides of the optical conduit subsystem 304. As will be appreciated by one of skill in the art in possession of the present disclosure, the use of magnets with the optical connector of the present disclosure will not require any added shielding (as would be required if provided on an electrical connector) due to the use of light to optically transmit data.

In a specific example, the magnets 306 and 308 may be provided by neodymium magnets that one of skill in the art in possession of the present disclosure will appreciate are relatively high strength magnets with relatively high temperature resistance that allow for the use of relatively small magnets in relatively high temperature environments like datacenters, although one of skill in the art in possession of the present disclosure will appreciate how other types of magnets may fall within the scope of the present disclosure as well. However, while a pair of specific types of magnets in a specific configuration is illustrated, one of skill in the art in possession of the present disclosure will appreciate how the connector magnetic securing subsystem on the optical connectors of the present disclosure may include a single magnet, or more than two magnets, in a variety of configurations while remaining within the scope of the present disclosure as well.

Furthermore, with reference to FIG. 3B, in some embodiments the connector magnetic securing subsystem on the optical connector 300 may be provided with a connector “keying” subsystem that is configured to ensure that the optical connector 300 is properly oriented with respect to a corresponding optical port in order to connect the optical connector 300 to that optical port. In the specific example illustrated in FIG. 3B, the connector keying system is provided by a pair of magnets 306a and 308a that are located on the base 302 on opposite sides of the optical conduit subsystem 304, with the magnet 306a provided with its north pole end exposed on the surface of the optical connector 300 (i.e., as indicated by the vertical lines on element 306a), and with the magnet 308a provided with its south pole end exposed on the surface of the optical connector 300 (as indicated by the horizontal lines on element 308a). As described below, the connector keying subsystem on the optical connector 300 may be configured to magnetically interact with a port keying subsystem on an optical port, and while a specific port/connector keying system is described, one of skill in the art in possession of the present disclosure will appreciate how the port/connector keying system of the present disclosure may be provided in a variety of manners while remaining within the scope of the present disclosure as well.

Furthermore, while the specific example provided above and discussed below includes magnets on the connector magnetic securing subsystem of the optical connector 300, one of skill in the art in possession of the present disclosure will appreciate how the connector magnetic securing subsystem of the optical connector 300 may instead be provided by a ferromagnetic material (e.g., Cobalt, Iron, Iron alloys (e.g., steel), Nickel, Gadolinium, Dysprosium, etc.) that is configured to magnetically interact with magnets included in a port magnetic securing subsystem on an optical port in other embodiments of the present disclosure that are discussed in further detail below. As such, in some embodiments, the material used to provide the front surface 404c of the optical connector 404 may be provided by a non-ferromagnetic material (e.g., any of a variety of plastic materials or other non-magnetic materials known in the art) to enable at least some of the functionality described below without interfering with the magnet/ferromagnetic material or magnet/magnet interactions described herein.

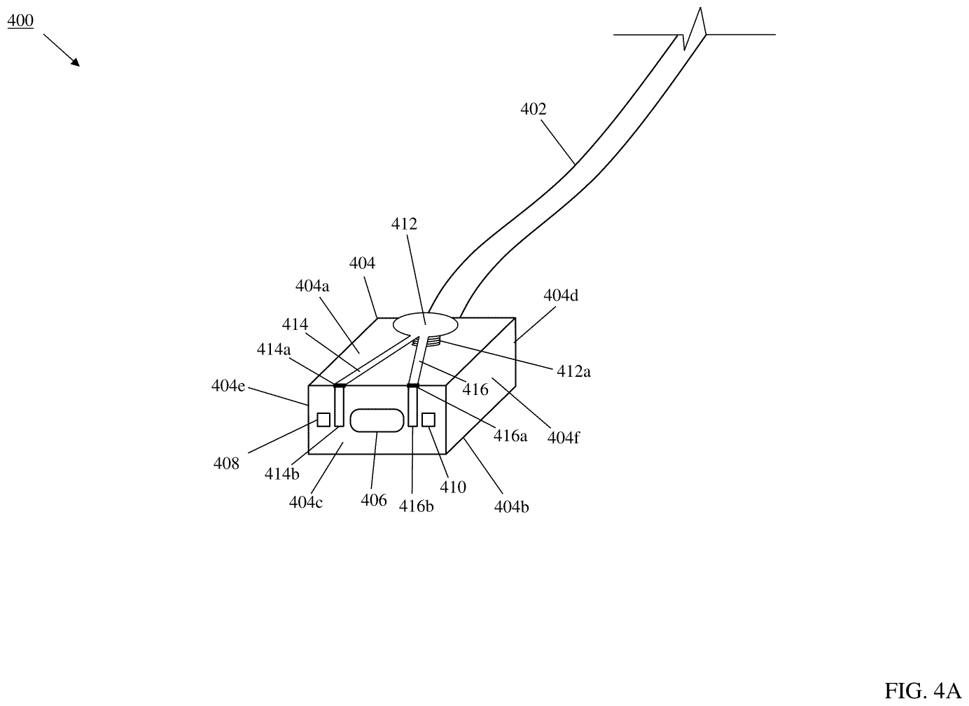

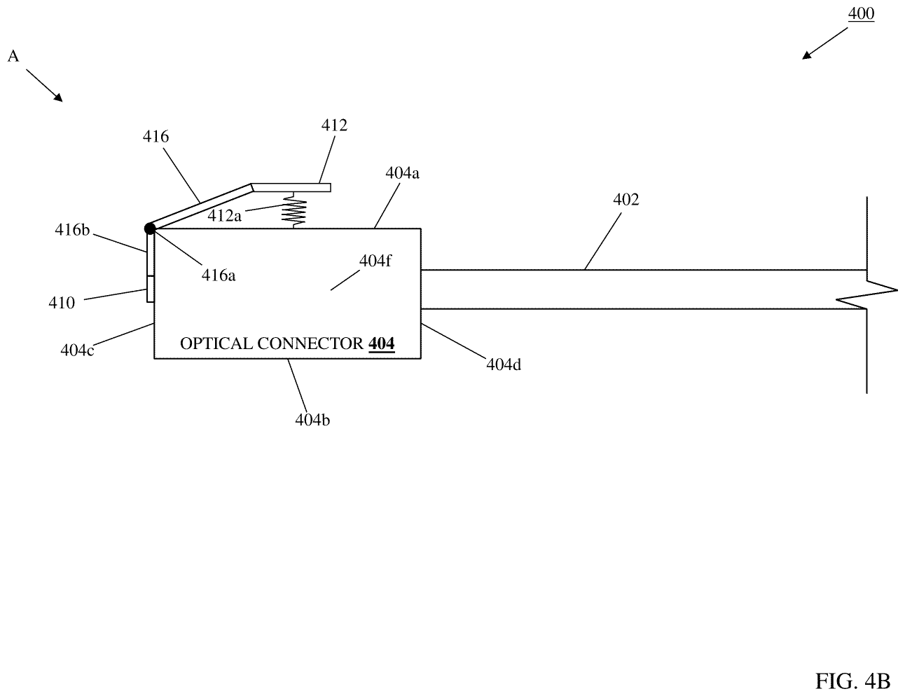

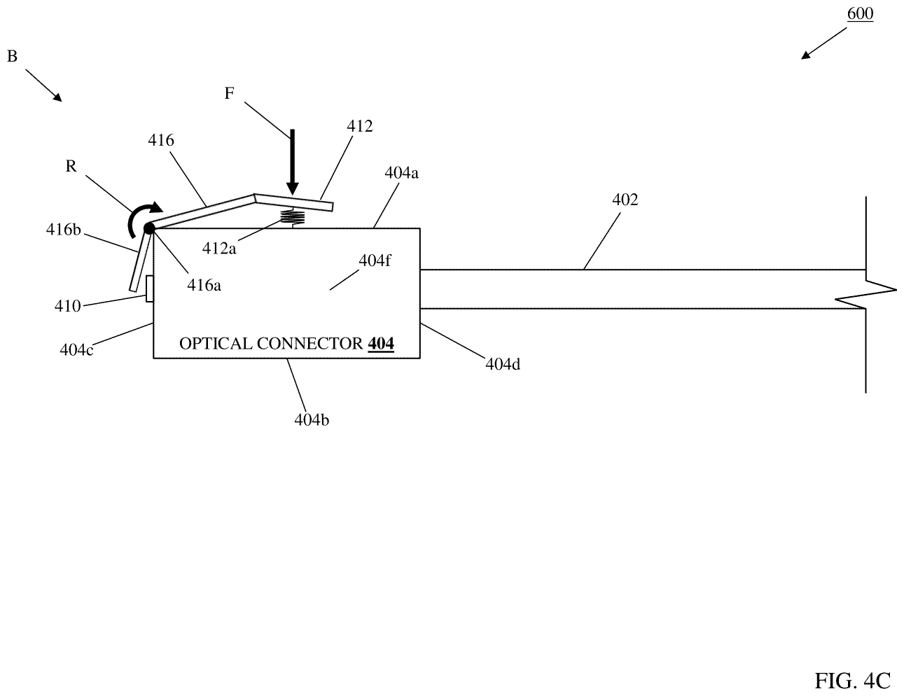

With reference to FIG. 4A, an embodiment of an optical cable system 400 is illustrated that may provide the optical cable system 200 discussed above with reference to FIG. 2. In the illustrated embodiment, the optical cable system 400 includes an optical cable 402 that may provide the optical cable 202 discussed above with reference to FIG. 2. As illustrated, an optical connector 404 that may provide the optical cable 204 discussed above with reference to FIG. 2 or the optical cable 300 discussed above with reference to FIGS. 3A and 3B is included on an end of the optical cable 402, and similarly as described above, at least one optical connector (and a plurality of optical connectors in the case of a “breakout” type cable) may be provided on opposing, unillustrated ends of the optical cable 402 while remaining within the scope of the present disclosure as well. In the illustrated embodiment, the optical connector 404 includes a top surface 404a, a bottom surface 404b that is located opposite the optical connector 404 from the top surface 404a, a front surface 404c that extends between the top surface 404a and the bottom surface 404b, a rear surface 404d that is located opposite the optical connector 404 from the front surface 404c and that extends between the top surface 404a and the bottom surface 404b, and a pair of side surfaces 404e and 404f that are located opposite the optical connector 404 from each other and that each extend between the top surface 404a, the bottom surface 404b, the front surface 404c, and the bottom surface 404d.

As will be appreciated by one of skill in the art in possession of the present disclosure, the optical cable 402 extends from the rear surface 404d of the optical connector 404, and may include optical fiber(s) that are coupled to an optical conduit subsystem 406 (e.g., fiber ferrule(s) and other optical components known in the art) that is included in the optical connector 404 and a portion of which is accessible on the front surface 404c of the optical connector 404. In the illustrated embodiments, a connector magnetic securing subsystem is included on the optical connector 404, and in the illustrated examples is provided by a pair of magnets 408 and 410 that are located on the front surface 404c of the optical connector 404 and on opposite sides of the optical conduit subsystem 406. As will be appreciated by one of skill in the art in possession of the present disclosure, the magnets 408a and 410 that provide the connector magnetic securing subsystem on the optical connector 404 may be provided by the magnets 306 and 308 discussed above with reference to FIG. 3A, or the magnets 306a and 308a discussed above with reference to FIG. 3B.

Furthermore, a mechanical release device is included on the optical connector 404, and in the illustrated example is provided by an actuator element 412 that is resiliently coupled to the top surface 404a of the optical connector 404 by a spring device 412a, along with a pair of arm members 414 and 416 that extend from the actuator element 412 (and away from each other along their length) to a moveable coupling on the optical connector 404 that is provided by respective hinges 414a and 416a that are spaced apart on the corner of the optical connector 404 between the top surface 404a and the front surface 404c, with each arm member 414 and 416 including a port engagement portion 414b and 416b, respectively, that extends from their respective hinges 414a and 416a substantially parallel to each other and adjacent the front surface 404c of the optical connector 404.

As illustrated in FIGS. 4B and 4C, the mechanical release device on the optical connector 404 is moveable between a securing orientation A (illustrated in FIG. 4B) and a release orientation B (illustrated in FIG. 4C). For example, in response to a force F applied to the actuator element 412 (e.g., via a finger of the user of the optical cable system 400) that is sufficient to compress the spring device 412a, the arm members 414 and 416 may rotate in a direction R about their respective hinges 414a and 416a such that their respective port engagement portions 414b and 416b move away from the front surface 404c of the optical connector 404. However, while a specific mechanism for the mechanical release device on the optical connector 404 is illustrated and described, one of skill in the art in possession of the present disclosure will appreciate how the mechanical release functionality of the present disclosure may be provided by a variety of mechanisms that will fall within the scope of the present disclosure as well. Furthermore, while several specific examples and embodiments of optical cable systems have been illustrated and described, one of skill in the art in possession of the present disclosure will recognize that the optical cable system of the present disclosure may include a variety of components and component configurations for providing conventional optical cable functionality, as well as the optical port/connector magnetic secure/release functionality discussed below, while remaining within the scope of the present disclosure as well.

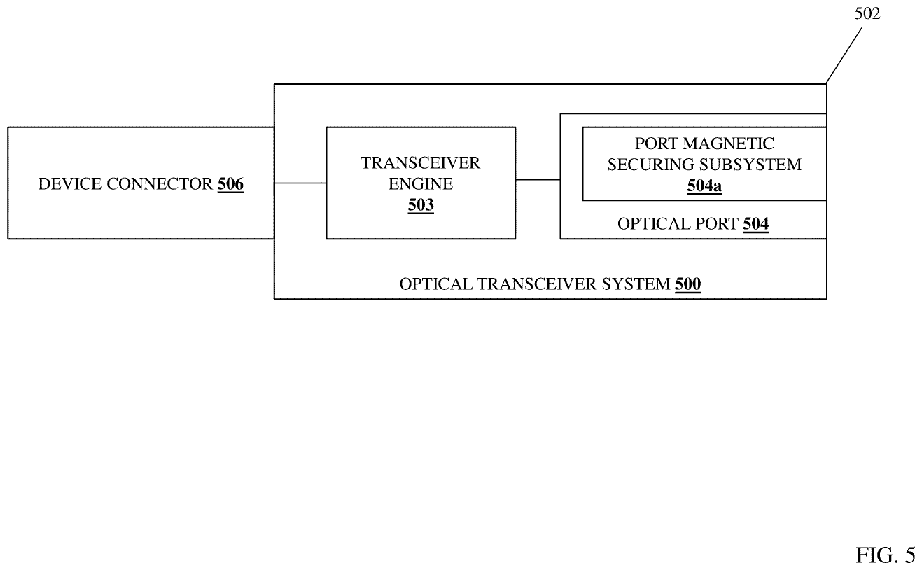

Referring now to FIG. 5, an embodiment of an optical transceiver system 500 is illustrated that may be used with the optical cable system 200 of FIG. 2. In an embodiment, the optical transceiver system 500 may be provided by the IHS 100 discussed above with reference to FIG. 1 and/or may include some or all of the components of the IHS 100, and in specific examples may be provided by Small Form-factor Pluggable (SFP) optical transceivers, enhanced SFP (SFP+) optical transceivers, 10-gigabit SFP (XFP) optical transceivers, Quad SFP (QSFP) optical transceivers, and/or other optical transceivers that would be apparent to one of skill in the art in possession of the present disclosure. Furthermore, while illustrated and discussed as being provided by specific optical transceivers, one of skill in the art in possession of the present disclosure will recognize that the functionality of the optical transceiver system 500 discussed below may be provided by other devices that are configured to operate similarly as the optical transceiver system 500 discussed below.

In the illustrated embodiment, the optical transceiver system 500 includes a chassis 502 that houses the components of the optical transceiver system 500, only some of which are illustrated and described below. For example, the chassis 502 may house a processing system (not illustrated, but which may be similar to the processor 102 discussed above with reference to FIG. 1) and a memory system (not illustrated, but which may be similar to the memory 114 discussed above with reference to FIG. 1) that is coupled to the processing system and that includes instructions that, when executed by the processing system, cause the processing system to provide a transceiver engine 503 that is configured to perform the functionality of the transceiver engines and/or optical transceiver systems discussed below.

The chassis 502 may also house an optical port 504 that is accessible via a surface of the chassis 502, that is coupled to the transceiver engine 503 (e.g., via a coupling between the optical port 504 and the processing system), and that may be configured to couple to any of the optical connectors described herein. As illustrated, a port magnetic securing subsystem 504a is included on the optical connector 504, and as described below may be configured in a variety of manners to secure any of the optical connectors described herein to the optical port 504. Furthermore, a device connector 506 is included on the chassis 502 and coupled to the transceiver engine 503 (e.g., via a coupling between the device connector 506 and the processing system), and may be provided by switch port connectors and/or other device port connectors that one of skill in the art in possession of the present disclosure would recognize as being configured to connect the optical transceiver system 500 to a conventional switch or other conventional computing devices known in the art. However, while a specific optical transceiver system 500 has been illustrated and described, one of skill in the art in possession of the present disclosure will recognize that optical transceiver systems (or other devices operating according to the teachings of the present disclosure in a manner similar to that described below for the optical transceiver system 500) may include a variety of components and/or component configurations for providing conventional optical transceiver functionality, as well as the optical port/connector magnetic secure/release functionality discussed below, while remaining within the scope of the present disclosure as well.

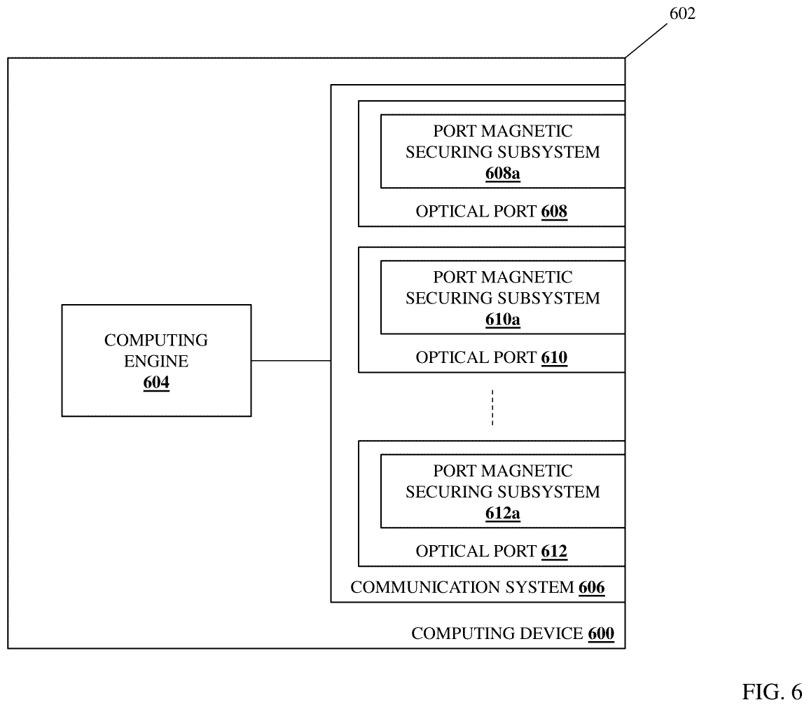

Referring now to FIG. 6, an embodiment of computing device 600 is illustrated that may be used with the optical cable system 200 of FIG. 2. In an embodiment, the computing device 600 may be provided by the IHS 100 discussed above with reference to FIG. 1 and/or may include some or all of the components of the IHS 100, and in specific examples may be provided by a switch device or other networking devices, storage systems, server devices, and/or other computing devices that would be apparent to one of skill in the art in possession of the present disclosure. Furthermore, while illustrated and discussed as being provided by specific devices, one of skill in the art in possession of the present disclosure will recognize that the functionality of the computing device 600 discussed below may be provided by other devices that are configured to operate similarly as the computing device 600 discussed below.

In the illustrated embodiment, the computing device 600 includes a chassis 602 that houses the components of the computing device 600, only some of which are illustrated and described below. For example, the chassis 602 may house a processing system (not illustrated, but which may be similar to the processor 102 discussed above with reference to FIG. 1) and a memory system (not illustrated, but which may be similar to the memory 114 discussed above with reference to FIG. 1) that is coupled to the processing system and that includes instructions that, when executed by the processing system, cause the processing system to provide a computing engine 604 that is configured to perform the functionality of the computing engines and/or computing devices discussed below.

In the illustrated embodiment, the chassis 602 houses a communication system 606 that includes plurality of optical ports 608, 610, and up to 612 that are each accessible via a surface of the chassis 602, that are each coupled to the computing engine 604 (e.g., via a coupling between that optical port and the processing system), and that may each be configured to couple to any of the optical connectors described herein. However, while one of skill in the art in possession of the present disclosure will appreciate that the computing device 600 is provided by a switch device having a plurality of optical ports in the examples provided herein, other computing devices may include fewer optical ports (including only a single optical port) while remaining within the scope of the present disclosure as well.

As illustrated, a port magnetic securing subsystem is included on each of the optical ports in the communication system 606, with a port magnetic securing subsystem 608a included on the optical port 608, a port magnetic securing subsystem 610a included on the optical port 610, and up to a port magnetic securing subsystem 612a included on the optical port 612. As described below, any of the port magnetic securing subsystems 608a-612a may be configured in a variety of manners to secure any of the optical connectors described herein to their optical port 608-612, respectively. However, while a specific computing device 600 has been illustrated and described, one of skill in the art in possession of the present disclosure will recognize that computing devices (or other devices operating according to the teachings of the present disclosure in a manner similar to that described below for the computing device 600) may include a variety of components and/or component configurations for providing conventional computing functionality, as well as the optical port/connector magnetic secure/release functionality discussed below, while remaining within the scope of the present disclosure as well.

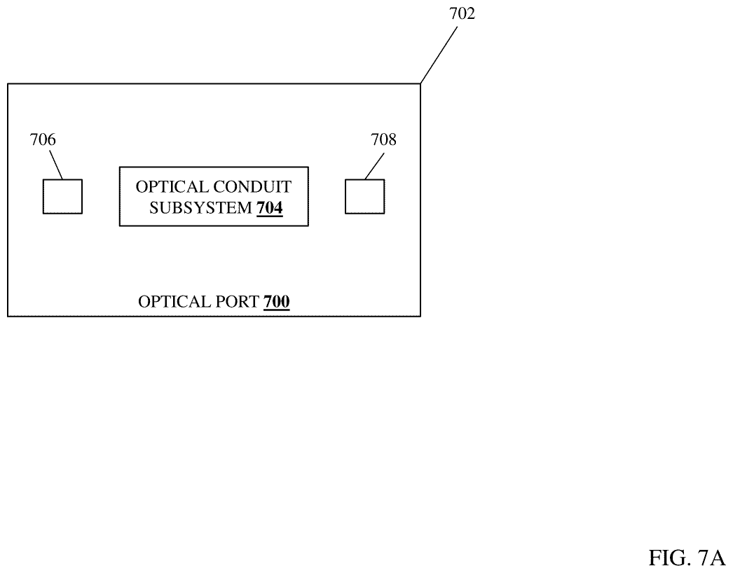

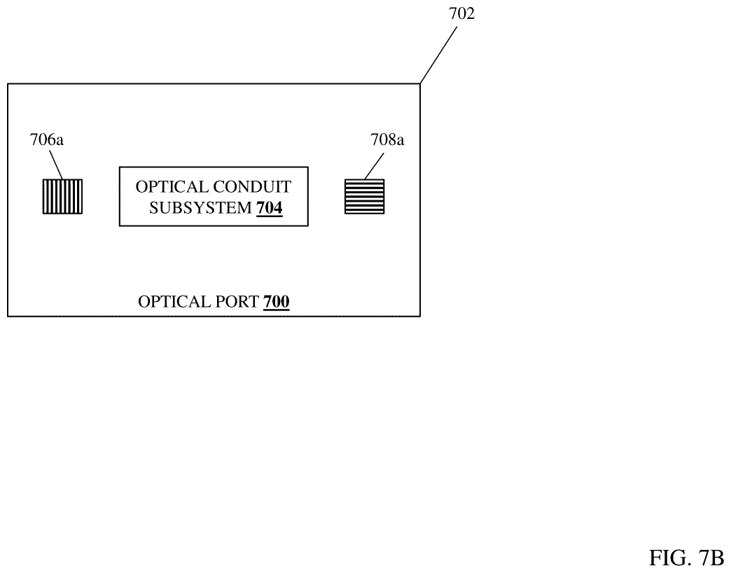

With reference to FIG. 7A, an embodiment of an optical port 700 is illustrated that may provide any of the optical port 504 discussed above with reference to FIG. 5, or the optical ports 608-612 discussed above with reference to FIG. 6. In the illustrated embodiment, the optical port 700 includes a base 702 having an optical conduit subsystem 704 that one of skill in the art in possession of the present disclosure will appreciate may include fiber ferrule receiver(s) and/or other fiber optic components known in the art. As will be appreciated by one of skill in the art in possession of the present disclosure, the base 702 and the optical conduit subsystem 704 of the optical port 700n may be similar to conventional fiber optic ports that are configured to connect to conventional fiber optic connectors (e.g., the LCs, SCs, FC connectors, ST connectors, and MPO connectors discussed above, as well as other fiber optic connectors known in the art), but with the optical connector alignment and connection components on those conventional fiber optic ports replaced by the optical connector alignment and connection components described below.

As illustrated, the base 702 of the optical port 700 may include a port magnetic securing subsystem that provides any of the port magnetic securing subsystem 504a on the optical port 504 discussed above with reference to FIG. 5, or the port magnetic securing subsystems 608a-612a on the optical ports 608-612 discussed above with reference to FIG. 6. In the examples illustrated and described below, the port magnetic securing subsystem on the optical port 700 may include a pair of magnets 706 and 708 that are located on the base 702 on opposite sides of the optical conduit subsystem 704. As will be appreciated by one of skill in the art in possession of the present disclosure, the use of magnets with the optical port of the present disclosure will not require any added shielding (as would be required if provided on an electrical port) due to the use of light to optically transmit data.

In a specific example, the magnets 706 and 708 may be provided by neodymium magnets that one of skill in the art in possession of the present disclosure will appreciate are relatively high strength magnets with relatively high temperature resistance that allow for the use of relatively small magnets in relatively high temperature environments like datacenters, although one of skill in the art in possession of the present disclosure will appreciate how other types of magnets may fall within the scope of the present disclosure as well. However, while a pair of specific types of magnets in a specific configuration is illustrated, one of skill in the art in possession of the present disclosure will appreciate how the port magnetic securing subsystem on the optical ports of the present disclosure may include a single magnet, or more than two magnets, in a variety of configurations while remaining within the scope of the present disclosure as well.

Furthermore, with reference to FIG. 7B, in some embodiments the port magnetic securing subsystem on the optical port 700 may be provided with a port “keying” subsystem that is configured to ensure that an optical connector provided according to the teachings of the present disclosure is properly oriented with respect to the optical port 700 in order to connect that optical connector to the optical port 700. In the specific example illustrated in FIG. 7B, the port keying system is provided by a pair of magnets 706a and 708a that are located on the base 702 on opposite sides of the optical conduit subsystem 704, with the magnet 706a provided with its north pole end exposed on the surface of the optical port 700 (i.e., as indicated by the vertical lines on element 706a), and with the magnet 708a provided with its south pole end exposed on the surface of the optical port 700 (as indicated by the horizontal lines on element 708a). As described below, the port keying subsystem on the optical port 700 may be configured to magnetically interact with a connector keying subsystem on an optical connector, and while a specific port/connector keying system is described, one of skill in the art in possession of the present disclosure will appreciate how the port/connector keying system of the present disclosure may be provided in a variety of manners while remaining within the scope of the present disclosure as well.

Furthermore, while the specific example provided above and discussed below includes magnets on the port magnetic securing subsystem of the optical port 700, one of skill in the art in possession of the present disclosure will appreciate how the port magnetic securing subsystem of the optical port 700 may instead be provided by a ferromagnetic material (e.g., Cobalt, Iron, Iron alloys (e.g., steel), Nickel, Gadolinium, Dysprosium, etc.) that is configured to magnetically interact with magnets included in a connector magnetic securing subsystem on an optical connector in other embodiments of the present disclosure that are discussed in further detail below. As such, in some embodiments, the material used to provide the front surface of the optical port 700 upon which the port magnetic securing subsystem is located may be provided by a non-ferromagnetic material (e.g., any of a variety of plastic materials or other non-magnetic materials known in the art) to enable at least some of the functionality described below without interfering with the magnet/ferromagnetic material or magnet/magnet interactions described herein.

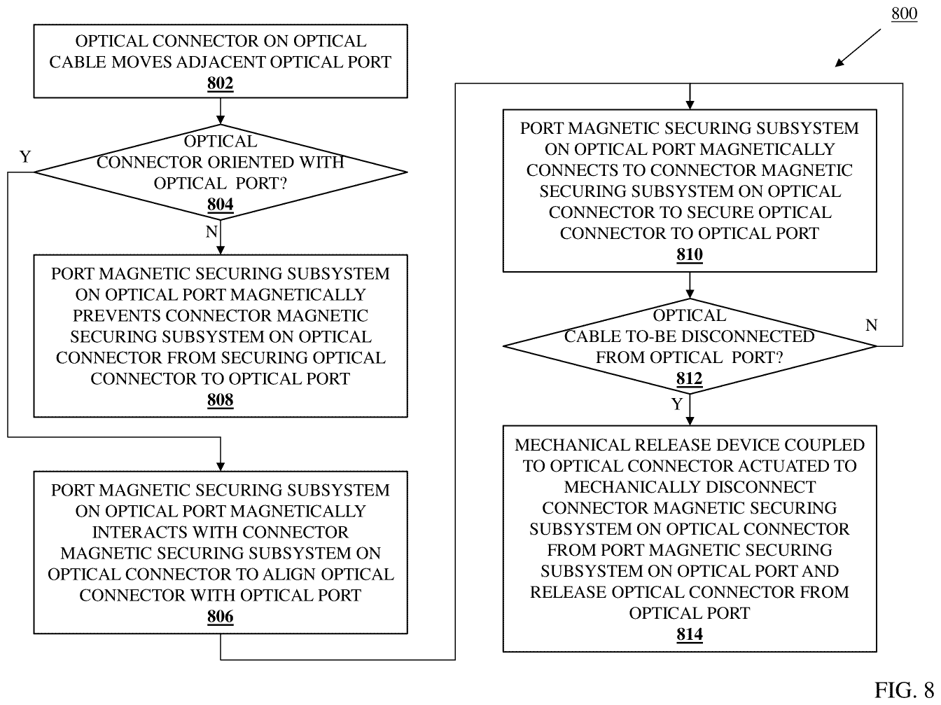

Referring now to FIG. 8, an embodiment of a method 800 for magnetically securing and releasing an optical connector to and from and an optical port is illustrated. As discussed below, the systems and methods of the present disclosure provide magnetic securing subsystems on an optical connector and optical port that are configured to magnetically interact to align and connect with each other to secure the optical connector to the optical port (while preventing their connection if the optical connector is misoriented with the optical port in some embodiments), along with a mechanical release device on the optical connector that is configured to mechanically disconnect the magnetic securing subsystems on the optical connector and the optical port to release the optical connector from the optical port. For example, the optical cable system of the present disclosure may include an optical cable and an optical connector that is included on the optical cable. A connector magnetic securing subsystem is included on the optical connector and is configured to magnetically connect to a port magnetic securing subsystem on an optical port to secure the optical connector to an optical port. A mechanical release device is coupled to the optical connector and is configured to mechanically disconnect the connector magnetic securing subsystem from the port magnetic securing subsystem to release the optical connector from the optical port. As such, the securing and release of optical connectors and optical ports is enabled while eliminating the issues with conventional optical port/connector secure/release systems discussed above.

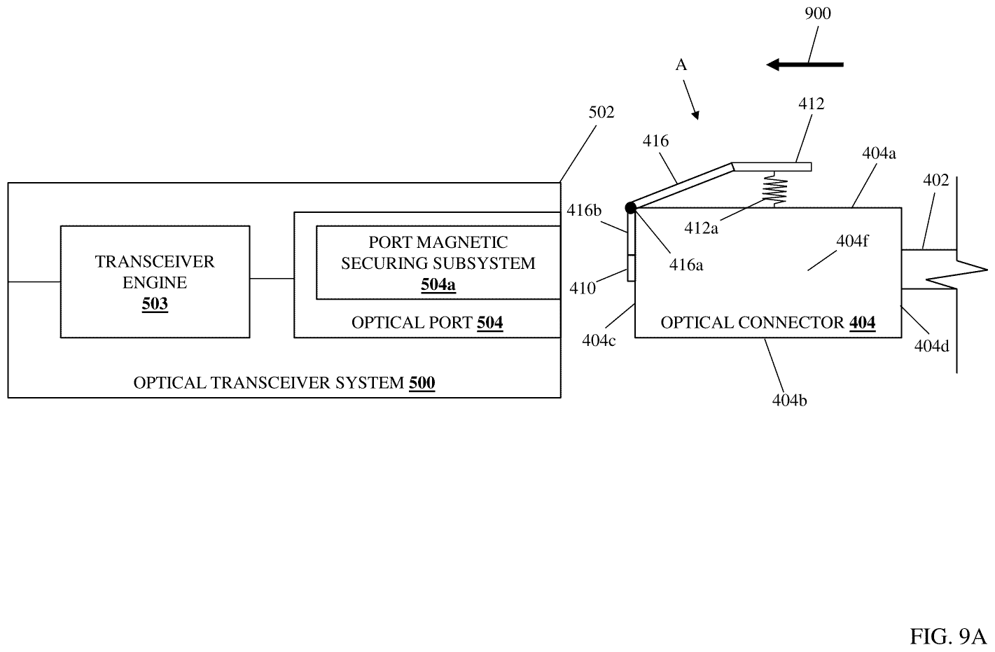

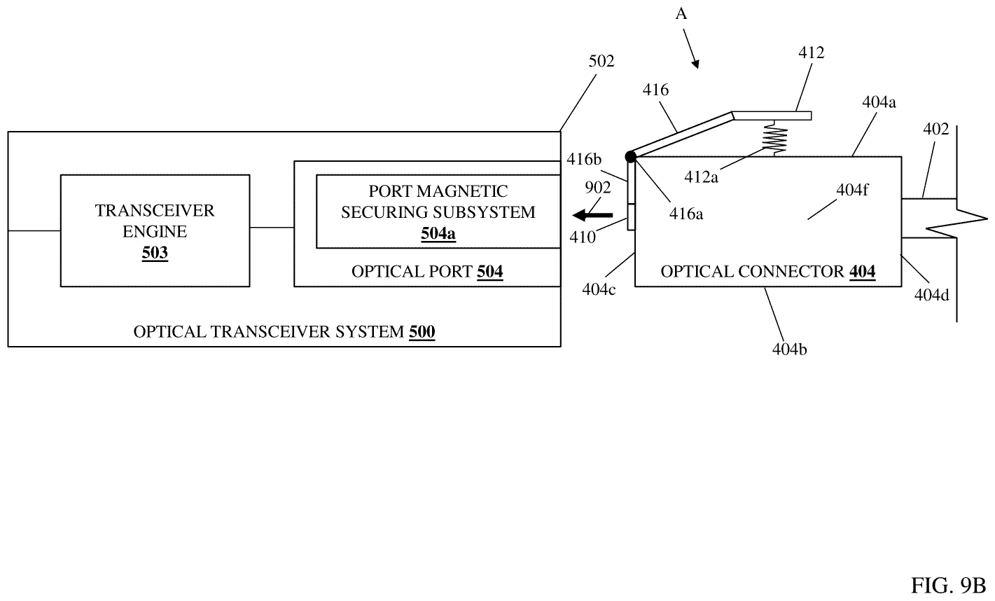

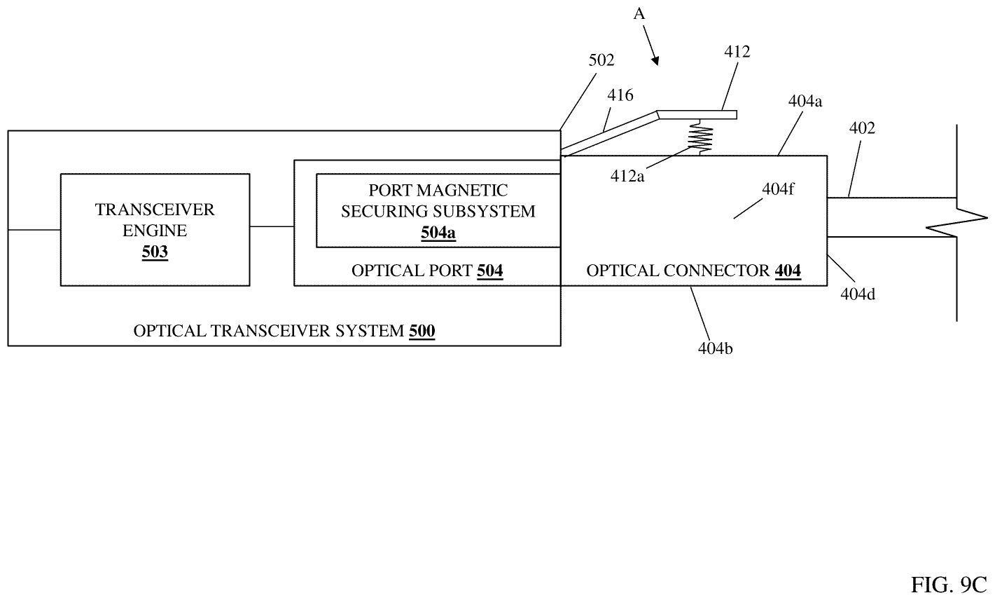

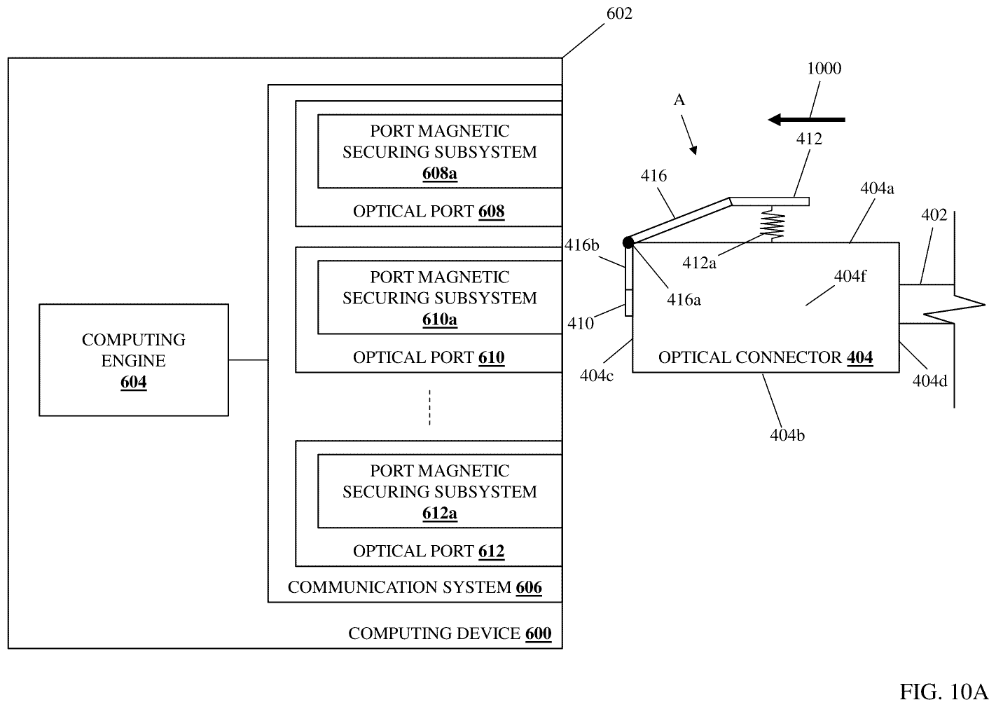

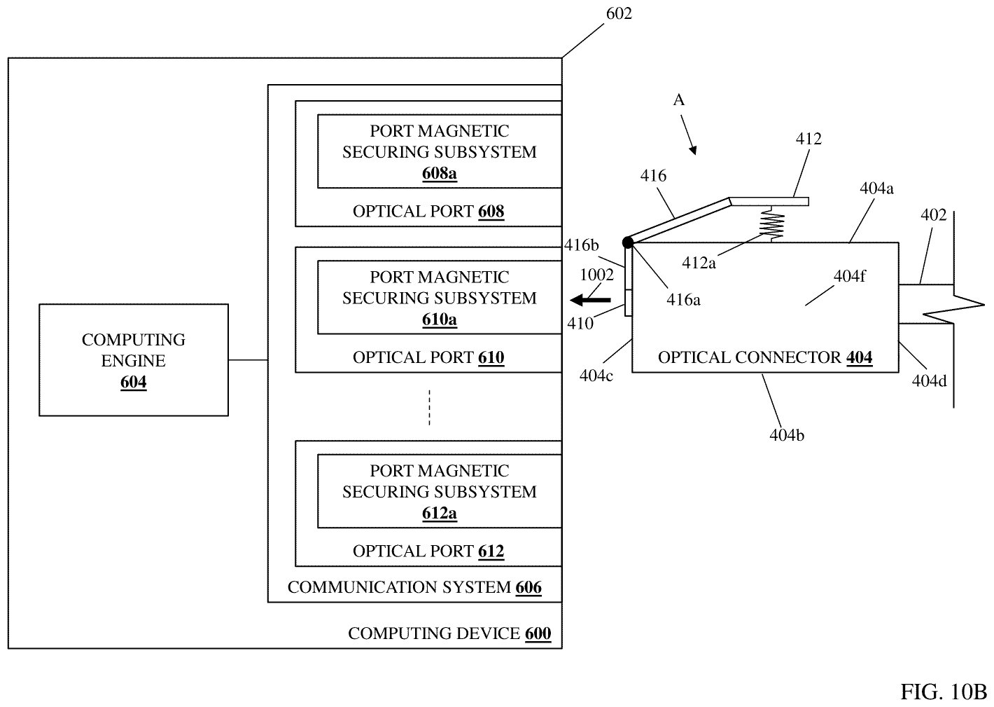

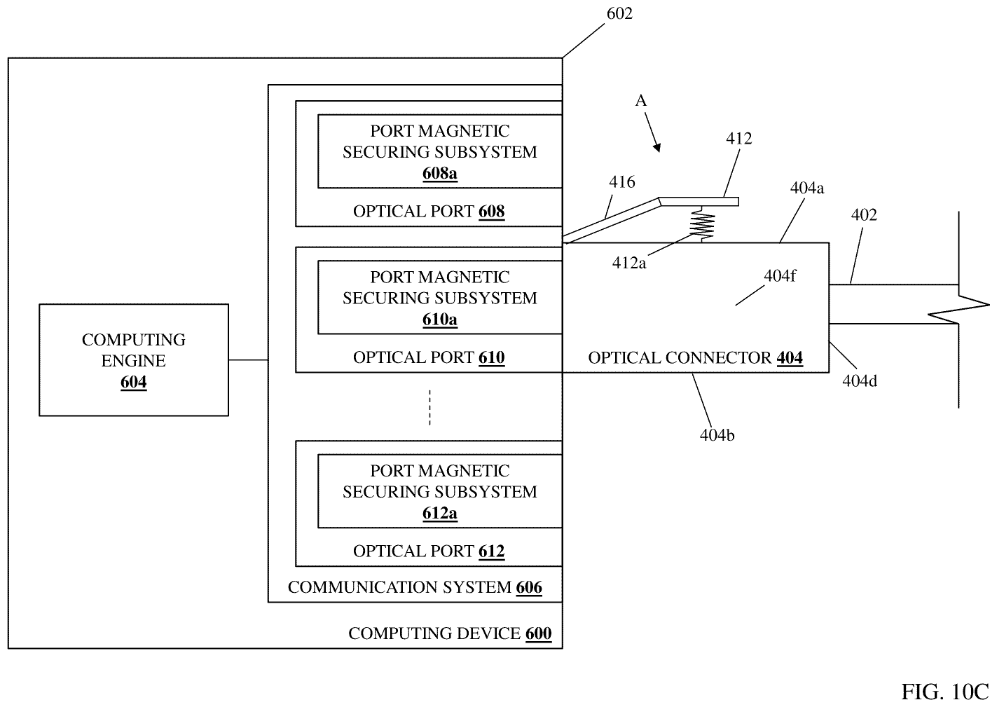

The method 800 begins at block 802 where an optical connector on an optical cable moves adjacent an optical port. With reference to FIG. 9A, in an embodiment of block 802, the optical connector 404 on the optical connector 404 included on the optical cable system 400 may be moved in a direction 900 and adjacent the optical port 504 on the optical transceiver system 500, and one of skill in the art in possession of the present disclosure will appreciate how the optical connector 404 is illustrated in FIG. 9A as being oriented with the optical port 504 in a manner that would provide for proper connection with the optical port 504. With reference to FIG. 10A, in another embodiment of block 802, the optical connector 404 on the optical connector 404 included on the optical cable system 400 may be moved in a direction 1000 and adjacent the optical port 610 on the computing device 600, and one of skill in the art in possession of the present disclosure will appreciate how the optical connector 404 is illustrated in FIG. 10A as being oriented with the optical port 610 in a manner that would provide for proper connection with the optical port 610.

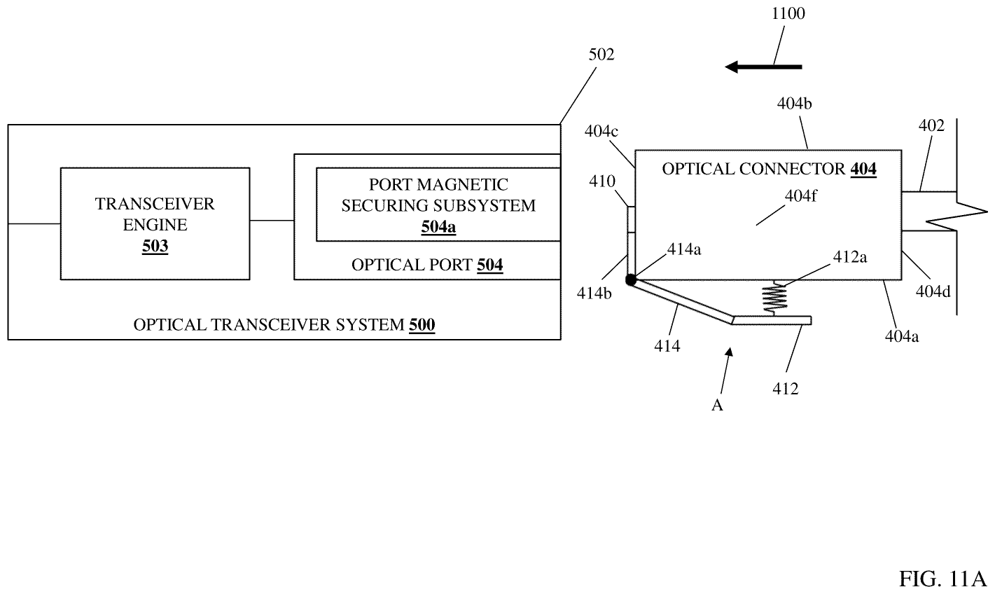

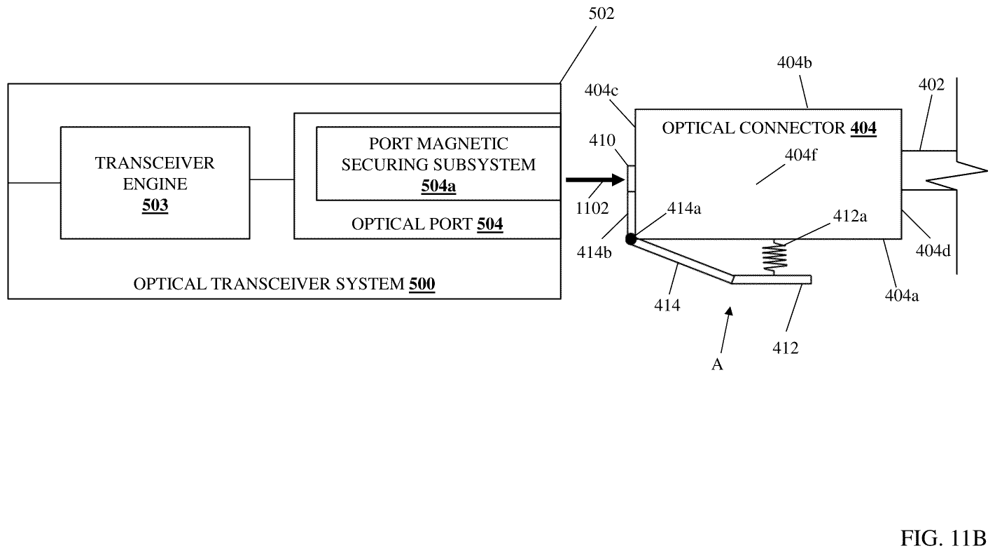

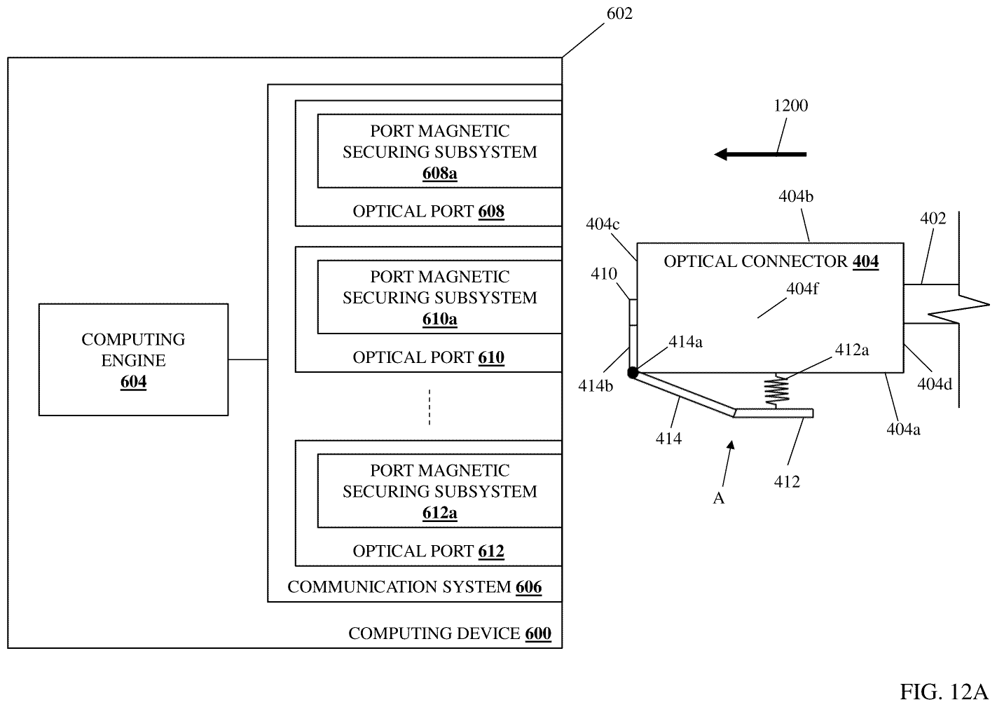

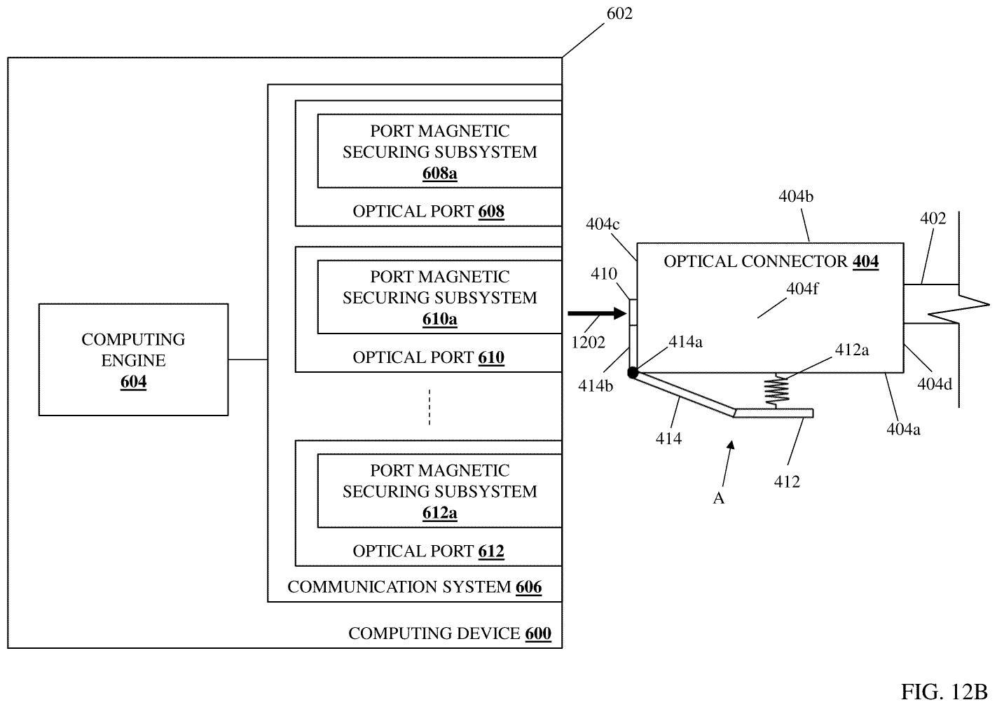

With reference to FIG. 11A, in another embodiment of block 802, the optical connector 404 on the optical connector 404 included on the optical cable system 400 may be moved in a direction 1100 and adjacent the optical port 504 on the optical transceiver system 500, and one of skill in the art in possession of the present disclosure will appreciate how the optical connector 404 is illustrated in FIG. 11A as being misoriented with the optical port 504 in a manner that would not provide for proper connection with the optical port 504. With reference to FIG. 12A, in another embodiment of block 802, the optical connector 404 on the optical connector 404 included on the optical cable system 400 may be moved in a direction 1200 and adjacent the optical port 610 on the computing device 600, and one of skill in the art in possession of the present disclosure will appreciate how the optical connector 404 is illustrated in FIG. 12A as being misoriented with the optical port 610 in a manner that would not provide for proper connection with the optical port 610.

The method 800 then proceeds to decision block 804 where the method 800 proceeds depending on whether the optical connector is oriented with the optical port. In the embodiments illustrated and described below, the magnetic securing subsystems on the optical connector and optical port of the present disclosure are configured with a keying system (e.g., provided by the connector keying subsystem and port keying subsystem described above) to prevent securing of the optical connector to the optical port if they are misoriented, and thus the method 400 may proceed at decision block 804 depending on whether the optical connector and optical port or oriented or misoriented. However, one of skill in the art in possession of the present disclosure will appreciate how such functionality is optional in the optical port/connector magnetic securing/release system of the present disclosure, and thus the method 400 may proceed from block 802 directly to block 806 in embodiments in which the keying system is omitted.

If, at decision block 804, the optical connector is oriented with the optical port, the method 800 proceeds to block 806 where a port magnetic securing subsystem on the optical port magnetically interacts with a connector magnetic securing subsystem on the optical connector to align the optical connector with the optical port. With reference to FIG. 9B, in an embodiment of block 806 and following the movement of the optical connector 404 adjacent the optical port 504 when the optical connector 404 is oriented with the optical port 504 as described above with reference to FIG. 9A, the connector magnetic securing subsystem on the optical connector 404 (e.g., provided by the magnets 408 and 410 in the illustrated embodiment) will magnetically interact with the port magnetic securing subsystem 504a on the optical port 504 to produce a magnetic attraction force 902 that pulls the optical connector 404 towards the optical port 504.

Furthermore, one of skill in the art in possession of the present disclosure will appreciate how the connector magnetic securing subsystem on the optical connector 404 and the port magnetic securing subsystem 504a on the optical port 504 may be configured (e.g., via the magnets 408 and 410 that provide the connector magnetic securing subsystem on the optical connector 404 and corresponding ferromagnetic material that provides the port magnetic securing subsystem 504a on the optical port 504, via magnets that provide the port magnetic securing subsystem 504a on the optical port 504 and corresponding ferromagnetic material that provides the connector magnetic securing subsystem on the optical connector 404, via the magnets 408 and 410 that provide the connector magnetic securing subsystem on the optical connector 404 and corresponding magnets that provide the port magnetic securing subsystem 504a on the optical port 504, etc.) to cause the optical connector 404 to align with the optical port 504 (e.g., such that fiber ferrule(s) that are included in the optical conduit subsystem 406 and that are moveably coupled to the optical connector 404 via a spring align with fiber ferrule receiver(s) on the optical conduit subsystem 704 of the optical port 700 that provides the optical port 504).

With reference to FIG. 10B, in an embodiment of block 806 and following the movement of the optical connector 404 adjacent the optical port 610 when the optical connector 404 is oriented with the optical port 610 as described above with reference to FIG. 10A, the connector magnetic securing subsystem on the optical connector 404 (e.g., provided by the magnets 408 and 410 in the illustrated embodiment) will magnetically interact with the port magnetic securing subsystem 610a on the optical port 610 to produce a magnetic attraction force 1002 that pulls the optical connector 404 towards the optical port 610. Similarly as described above, one of skill in the art in possession of the present disclosure will appreciate how the connector magnetic securing subsystem on the optical connector 404 and the port magnetic securing subsystem 610a on the optical port 610 may be configured (e.g., via the magnets 408 and 410 that provide the connector magnetic securing subsystem on the optical connector 404 and corresponding ferromagnetic material that provides the port magnetic securing subsystem 610a on the optical port 610, via magnets that provide the port magnetic securing subsystem 610a on the optical port 610 and corresponding ferromagnetic material that provides the connector magnetic securing subsystem on the optical connector 404, via the magnets 408 and 410 that provide the connector magnetic securing subsystem on the optical connector 404 and corresponding magnets that provide the port magnetic securing subsystem 610a on the optical port 610, etc.) to cause the optical connector 404 to align with the optical port 610 (e.g., such that fiber ferrule(s) that are included in the optical conduit subsystem 406 and that are moveably coupled to the optical connector 404 via a spring align with fiber ferrule receiver(s) on the optical conduit subsystem 704 of the optical port 700 that provides the optical port 610).

If, at decision block 804, the optical connector is misoriented with the optical port, the method 800 proceeds to block 808 where the port magnetic securing subsystem on the optical port magnetically prevents the connector magnetic securing subsystem on the optical connector from securing the optical connector to the optical port. With reference to FIG. 11B, in an embodiment of block 806 and following the movement of the optical connector 404 adjacent the optical port 504 when the optical connector 404 is misoriented with the optical port 504 as described above with reference to FIG. 11A, the connector magnetic securing subsystem on the optical connector 404 (e.g., provided by the magnets 408 and 410 in the illustrated embodiment) will magnetically interact with the port magnetic securing subsystem 504a on the optical port 504 to produce a magnetic repulsion force 1102 that pushes the optical connector 404 away the optical port 504.

As discussed above, the connector magnetic securing subsystem on the optical connector 404 and the port magnetic securing subsystem 504a on the optical port 504 may be configured (e.g., via the magnets 306a and 308a that provide the connector magnetic securing subsystem on the optical connector 300 that provides the optical connector 404, and the magnets 706a and 708a that provide the port magnetic securing subsystem on the optical port 700 that provides the optical port 504, etc.) to prevent the optical connector 404 from connecting and securing with the optical port 504 when the optical connector 404 is misoriented with the optical port 504. One of skill in the art in possession of the present disclosure will appreciate how the movement of the magnets 306a and 706a that each have their north pole end exposed, as well as the movement of the magnets 306b and 706b that each have their south pole end exposed, adjacent each other will produce the magnetic repulsion force that will prevent engagement of the optical connector 404/300 and the optical port 504/700 (i.e., while also appreciating how the movement of the magnets 306a and 706b, as well as the movement of the magnets 306b and 706a, adjacent each other will produce the magnetic attraction force discussed above that will align and engage of the optical connector 404/300 and the optical port 504/700).

With reference to FIG. 12B, in an embodiment of block 806 and following the movement of the optical connector 404 adjacent the optical port 610 when the optical connector 404 is misoriented with the optical port 610 as described above with reference to FIG. 12A, the connector magnetic securing subsystem on the optical connector 404 (e.g., provided by the magnets 408 and 410 in the illustrated embodiment) will magnetically interact with the port magnetic securing subsystem 610a on the optical port 610 to produce a magnetic repulsion force 1202 that pushes the optical connector 404 away the optical port 610. As discussed above, the connector magnetic securing subsystem on the optical connector 404 and the port magnetic securing subsystem 610a on the optical port 610 may be configured (e.g., via the magnets 306a and 308a that provide the connector magnetic securing subsystem on the optical connector 300 that provides the optical connector 404, and the magnets 706a and 708a that provide the port magnetic securing subsystem on the optical port 700 that provides the optical port 610, etc.) to prevent the optical connector 404 from connecting and securing with the optical port 610 when the optical connector 404 is misoriented with the optical port 610. One of skill in the art in possession of the present disclosure will appreciate how the movement of the magnets 306a and 706a that each have their north pole end exposed, as well as the movement of the magnets 306b and 706b that each have their south pole end exposed, adjacent each other will produce the magnetic repulsion force that will prevent engagement of the optical connector 404/300 and the optical port 610/700 (i.e., while also appreciating how the movement of the magnets 306a and 706b, as well as the movement of the magnets 306b and 706a, adjacent each other will produce the magnetic attraction force discussed above that will align and engage of the optical connector 404/300 and the optical port 610/700).

Following block 806, the method 800 proceeds to block 810 where the port magnetic securing subsystem on the optical port magnetically connects to the connector magnetic securing subsystem on the optical connector to secure the optical connector to the optical port. With reference to FIG. 9C, in an embodiment of block 810 and in response to moving the optical connector 404 adjacent the optical port 504 such that the magnetic attraction force 902 discussed above with reference to FIG. 9B is produced, the connector magnetic securing subsystem on the optical connector 404 and the port magnetic securing subsystem 504a on the optical port 504 may magnetically connect (e.g., via the magnets 408 and 410 that provide the connector magnetic securing subsystem on the optical connector 404 and corresponding ferromagnetic material that provides the port magnetic securing subsystem 504a on the optical port 504, via magnets that provide the port magnetic securing subsystem 504a on the optical port 504 and corresponding ferromagnetic material that provides the connector magnetic securing subsystem on the optical connector 404, via the magnets 408 and 410 that provide the connector magnetic securing subsystem on the optical connector 404 and corresponding magnets that provide the port magnetic securing subsystem 504a on the optical port 504, etc.) to secure the optical connector 404 to the optical port 504 (e.g., such that fiber ferrule(s) that are included in the optical conduit subsystem 406 and that are moveably coupled to the optical connector 404 via a spring align with fiber ferrule receiver(s) on the optical conduit subsystem 704 of the optical port 700 that provides the optical port 504).

With reference to FIG. 10C, in another embodiment of block 810 and in response to moving the optical connector 404 adjacent the optical port 610 such that the magnetic attraction force 1002 discussed above with reference to FIG. 10B is produced, the connector magnetic securing subsystem on the optical connector 404 and the port magnetic securing subsystem 610a on the optical port 610 may magnetically connect (e.g., via the magnets 408 and 410 that provide the connector magnetic securing subsystem on the optical connector 404 and corresponding ferromagnetic material that provides the port magnetic securing subsystem 610a on the optical port 610, via magnets that provide the port magnetic securing subsystem 610a on the optical port 610 and corresponding ferromagnetic material that provides the connector magnetic securing subsystem on the optical connector 404, via the magnets 408 and 410 that provide the connector magnetic securing subsystem on the optical connector 404 and corresponding magnets that provide the port magnetic securing subsystem 610a on the optical port 610, etc.) to secure the optical connector 404 to the optical port 610 (e.g., such that fiber ferrule(s) that are included in the optical conduit subsystem 406 and that are moveably coupled to the optical connector 404 via a spring align with fiber ferrule receiver(s) on the optical conduit subsystem 704 of the optical port 700 that provides the optical port 610).

The method 800 then proceeds to decision block 812 where the method 800 proceeds depending on whether the optical cable is to-be disconnected from the optical port. As will be appreciated by one of skill in the art in possession of the present disclosure, following the connection of an optical cable to an optical port, a variety of reasons may arise in which that optical cable must be disconnected from that optical port, and thus the method 800 may proceed depending on whether the optical cable 400 must be disconnected from the optical port 504 or 610 and, thus, whether the mechanical release device of the present disclosure must be utilized. If, at decision block 812, the optical cable is not to-be disconnected from the optical port, the method 800 returns to block 810. As such, the method 800 may loop such that the port magnetic securing subsystem on the optical port remains magnetically connected to the connector magnetic securing subsystem on the optical connector to secure the optical connector to the optical port as long as the optical cable is not to-be disconnected from the optical port.

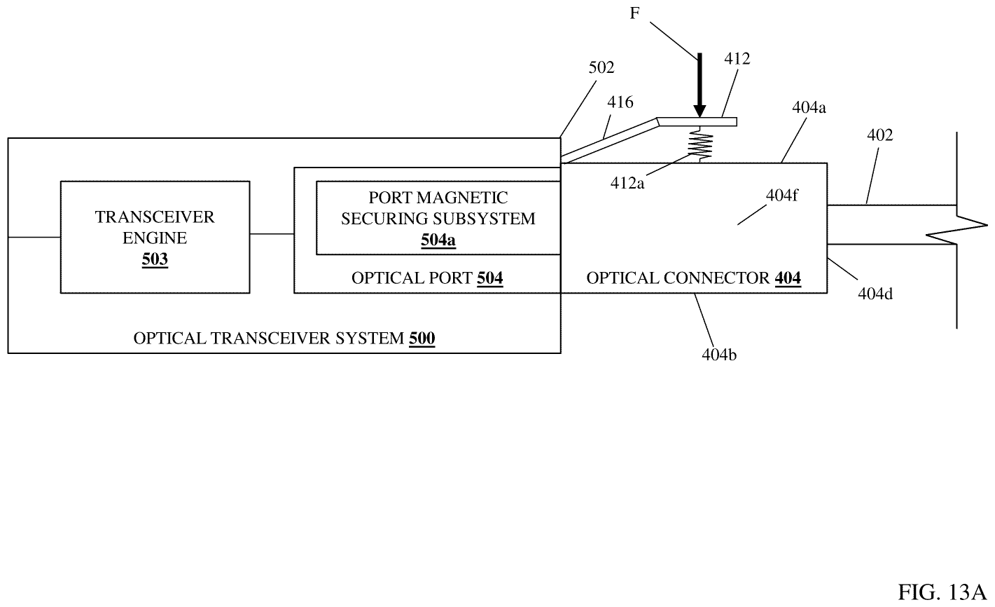

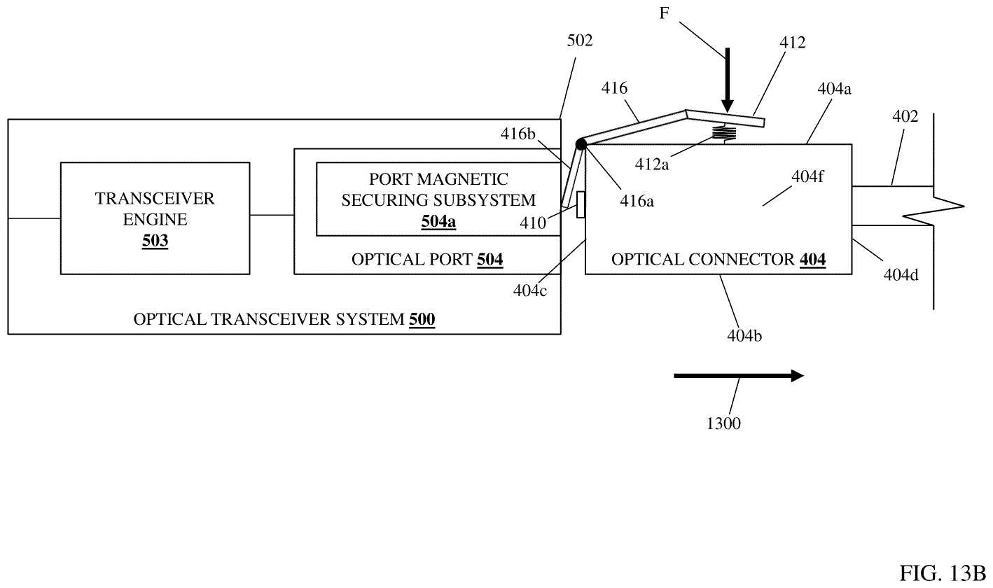

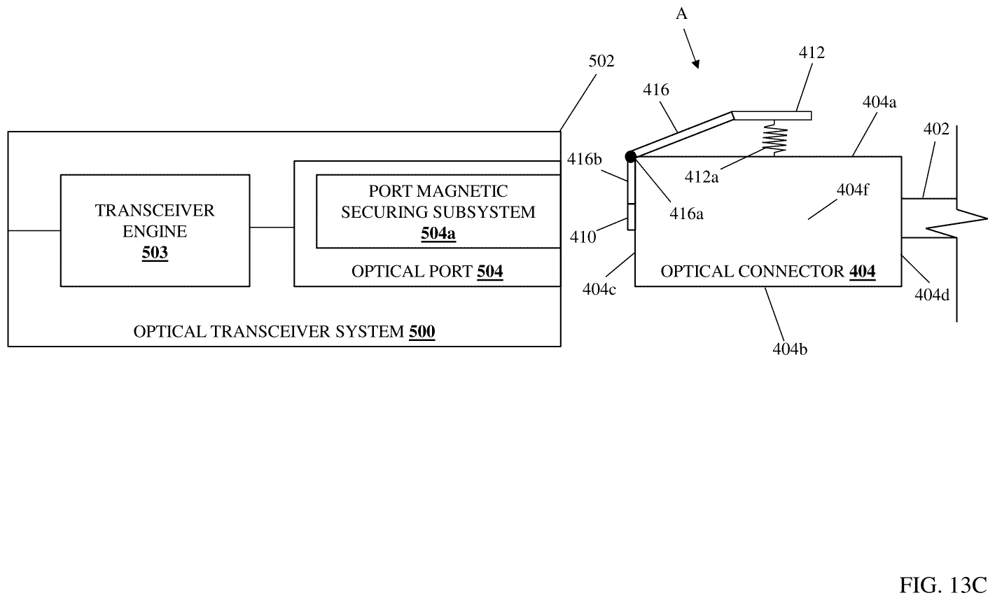

If, at decision block 812, optical cable is to-be disconnected from the optical port, the method 800 proceeds to block 814 where a mechanical release device coupled to the optical connector is actuated to mechanically disconnect the connector magnetic securing subsystem on the optical connector from the port magnetic securing subsystem on the optical port and release the optical connector from the optical port. With reference to FIGS. 13A, 13B, and 13C, in an embodiment of block 814 and with the mechanical release device on the optical connector 404 in the securing orientation A while the optical connector 440 is secured to the optical port 504, a user of the optical cable system 400 may apply the force F discussed above with reference to FIG. 4C to the actuator element 412 that is sufficient to compress the spring device 412a, which as described above causes the arm members 414 and 416 to rotate in a direction R about their respective hinges 414a and 416a such that their respective port engagement portions 414b and 416b move away from the front surface 404c of the optical connector 404 to position the mechanical release device on the optical connector 404 in the release orientation B, and one of skill in the art in possession of the present disclosure will appreciate how such movement of the port engagement portions 414b and 416b on the mechanical release device will cause those port engagement portions 414b and 416b to engage a surface of the optical port 504 to provide a release force that is directed away from the optical port 504 from the point of view of the optical connector 404.

Furthermore, one of skill in the art in possession of the present disclosure will appreciate how the mechanical advantage provided by the dimensions of the mechanical release device may be configured to produce a release force that is sufficient to overcome the magnetic attraction force between the connector magnetic securing subsystem on the optical connector 404 and the port magnetic securing subsystem 504a on the optical port 504 (e.g., a relatively significant magnetic attraction force that may be produced via the engagement of corresponding neodymium magnets used in at least some of the embodiments described above.) In response to actuating the mechanical release device and providing the release force that overcomes the magnetic attraction force between the connector magnetic securing subsystem on the optical connector 404 and the port magnetic securing subsystem 504a on the optical port 504, the user may move the optical connector 404 in a direction 1300 and away from the optical port 504 (while continuing to provide the force F on the actuator element 412 to ensure the magnetic attraction force between the connector magnetic securing subsystem on the optical connector 404 and the port magnetic securing subsystem 504a on the optical port 504 does not cause their reconnection). As illustrated in FIG. 13C, the user may then cease providing the force F on the actuator element 412, with the spring element 412a resiliently biasing the mechanical release device on the optical connector 404 from the release orientation B back into the securing orientation A.

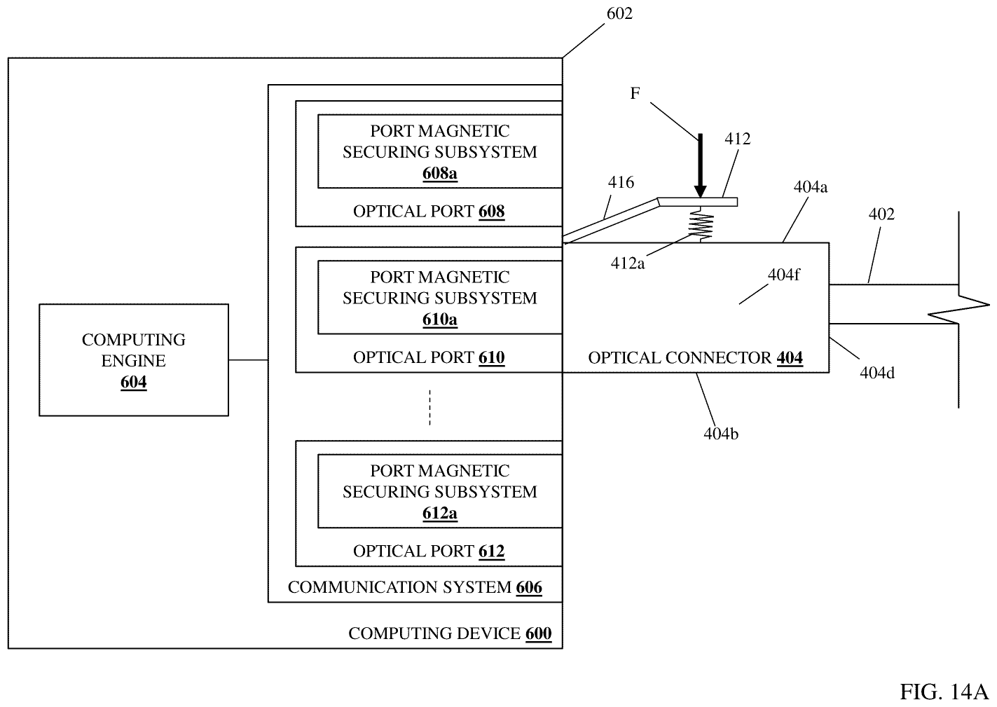

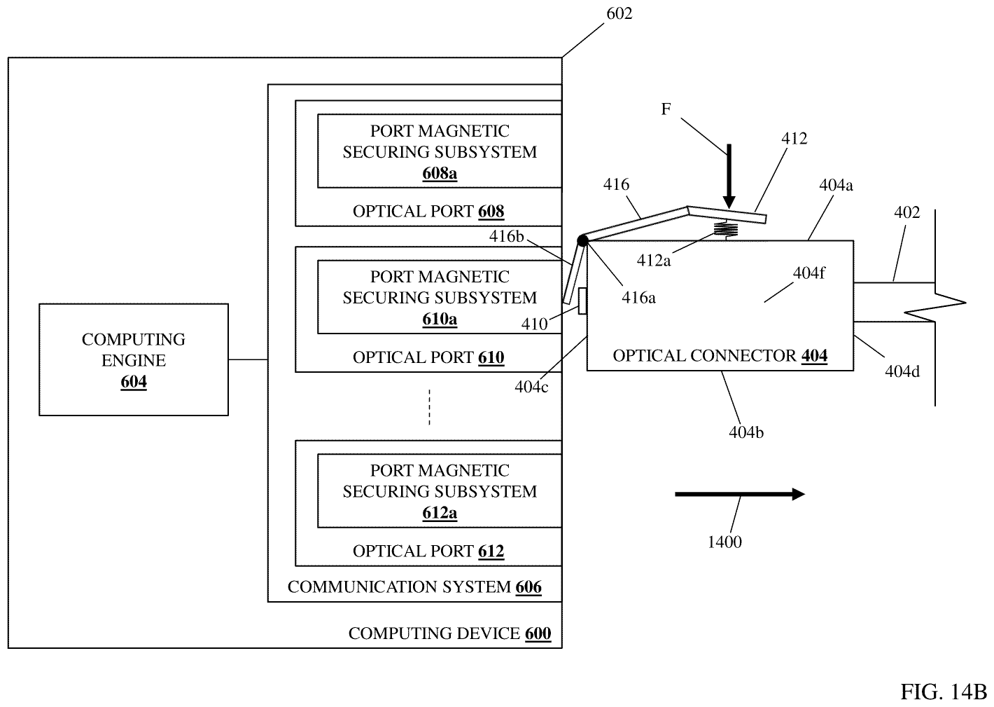

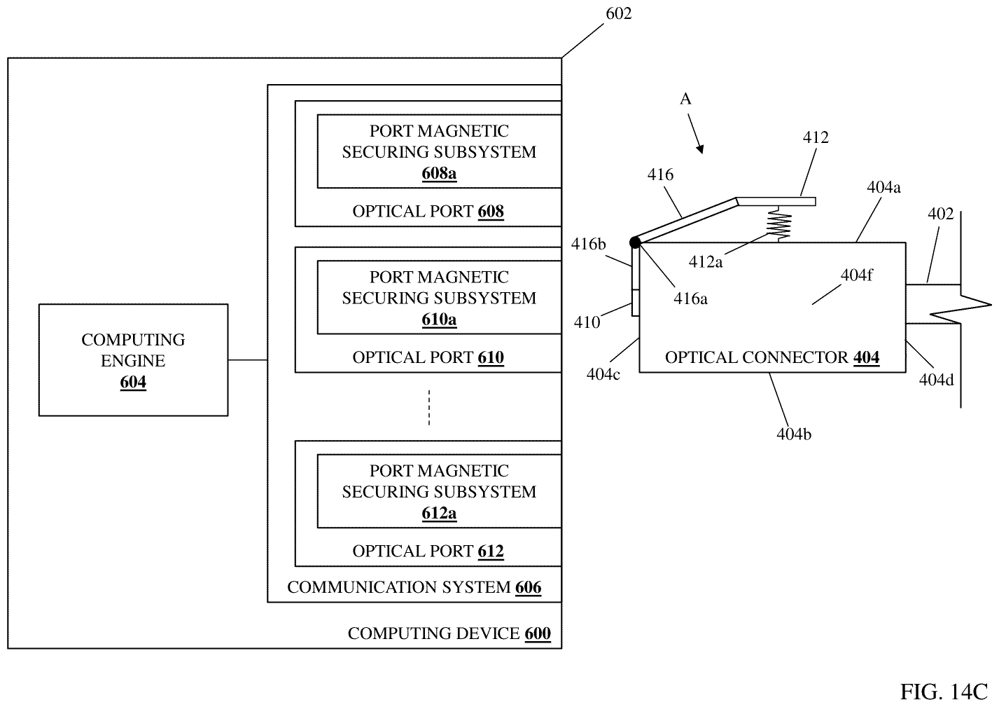

With reference to FIGS. 14A, 14B, and 14C, in an embodiment of block 814 and with the mechanical release device on the optical connector 404 in the securing orientation A while the optical connector 440 is secured to the optical port 610, a user of the optical cable system 400 may apply the force F discussed above with reference to FIG. 4C to the actuator element 412 that is sufficient to compress the spring device 412a, which as described above causes the arm members 414 and 416 to rotate in a direction R about their respective hinges 414a and 416a such that their respective port engagement portions 414b and 416b move away from the front surface 404c of the optical connector 404 to position the mechanical release device on the optical connector 404 in the release orientation B, and one of skill in the art in possession of the present disclosure will appreciate how such movement of the port engagement portions 414b and 416b on the mechanical release device will cause those port engagement portions 414b and 416b to engage a surface of the optical port 610 and provide a release force that is directed away from the optical port 610 from the point of view of the optical connector 404.

Similarly as described above, one of skill in the art in possession of the present disclosure will appreciate how the mechanical advantage provided by the dimensions of the mechanical release device may be configured to produce the release force that is sufficient to overcome the magnetic attraction force between the connector magnetic securing subsystem on the optical connector 404 and the port magnetic securing subsystem 610a on the optical port 610 (e.g., a relatively significant magnetic attraction force that may be produced via the engagement of corresponding neodymium magnets used in at least some of the embodiments described above.) In response to actuating the mechanical release device and providing the release force that overcomes the magnetic attraction force between the connector magnetic securing subsystem on the optical connector 404 and the port magnetic securing subsystem 610a on the optical port 610a, the user may move the optical connector 404 in a direction 1400 and away from the optical port 610 (while continuing to provide the force F on the actuator element 412 to ensure the magnetic attraction force between the connector magnetic securing subsystem on the optical connector 404 and the port magnetic securing subsystem 610a on the optical port 610 does not cause their reconnection). As illustrated in FIG. 14C, the user may then cease providing the force F on the actuator element 412, with the spring element 412a resiliently biasing the mechanical release device on the optical connector 404 from the release orientation B back into the securing orientation A.

As will be appreciated by one of skill in the art in possession of the present disclosure, the mechanical release device provided on the optical connectors of the present disclosure may be particularly useful in embodiments that utilize neodymium magnets in the magnetic securing subsystem(s) on the optical connector and/or the optical port, as the small size of magnets required for the optical port/connector connection/securing applications of the present disclosure combined with the high strength of neodymium magnets presents issues with those magnets breaking off from the component to which they are attached when an attempt is made to overcome the attractive magnetic force which they produce. For example, the magnetic attraction force produced by small neodymium magnets may be greater than the magnet/component attachment techniques used to attach those neodymium magnets to the optical connector and/or optical port, and a user pulling on the optical cable that includes the optical connector of the present disclosure may simply rip the magnet off the optical connector or optical port, or damage another part of the optical cable system before producing a force sufficient to overcome the attractive magnetic force produced by the neodymium magnets(s), and one of skill in the art in possession of the present disclosure will appreciate how the mechanical release device operates to prevent such optical cable system component damage.

Thus, systems and methods have been described that provide magnetic securing subsystems on an optical connector and optical port that are configured to magnetically interact to align and connect with each other to secure the optical connector to the optical port (while preventing their connection if the optical connector is misoriented with the optical port in some embodiments), along with a mechanical release device on the optical connector that is configured to mechanically disconnect the magnetic securing subsystems on the optical connector and the optical port to release the optical connector from the optical port. For example, the optical cable system of the present disclosure may include an optical cable and an optical connector that is included on the optical cable. A connector magnetic securing subsystem is included on the optical connector and is configured to magnetically connect to a port magnetic securing subsystem on an optical port to secure the optical connector to an optical port. A mechanical release device is coupled to the optical connector and is configured to mechanically disconnect the connector magnetic securing subsystem from the port magnetic securing subsystem to release the optical connector from the optical port. As such, the securing and release of optical connectors and optical ports is enabled while eliminating the issues with conventional optical port/connector secure/release systems discussed above.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An optical cable system, comprising:
an optical cable;
an optical connector that is included on the optical cable;
a connector magnetic securing subsystem that is included on the optical connector and that is configured to magnetically connect to a port magnetic securing subsystem on an optical port to secure the optical connector to an optical port; and
a mechanical release device that is coupled to the optical connector and that is configured to mechanically disconnect the connector magnetic securing subsystem from the port magnetic securing subsystem to release the optical connector from the optical port.

2. The system of claim 1, wherein the connector magnetic securing subsystem includes a plurality of neodymium magnets.

3. The system of claim 1, wherein the optical connector includes an optical conduit subsystem, and wherein the mechanical release device is located adjacent the optical conduit subsystem when in a securing orientation while the optical connector is secured to the optical port, and includes a moveable connection to the optical connector that configures the mechanical release device to move relative to the optical connector and into a release orientation in which the mechanical release device extends from the optical connector and into engagement with the optical port to release the optical connector from the optical port.

4. The system of claim 1, wherein the connector magnetic securing subsystem includes a plurality of connector magnets that are configured to magnetically interact with the port magnetic securing subsystem to align the optical connector with the optical port.

5. The system of claim 4, wherein the port magnetic securing subsystem includes respective ferromagnetic elements for each of the plurality of connector magnets.

6. The system of claim 1, wherein the connector magnetic subsystem includes a plurality of connector magnets that are configured to magnetically interact with corresponding port magnets included in the port magnetic securing subsystem to align and connect the optical connector with the optical port when the optical connector is oriented with the optical port, and that are configured to magnetically interact with the corresponding port magnets included in the port magnetic securing subsystem to prevent connection of the optical connector with the optical port when the optical connector is misoriented with the optical port.

7. An Information Handling System (IHS), comprising:
a chassis;
a processing system that is housed in the chassis;
an optical port that is included on the chassis and that is coupled to the processing system;
a port magnetic securing subsystem that is included on the optical port;
an optical cable;
an optical connector that is included on the optical cable;
a connector magnetic securing subsystem that is included on the optical connector and that is magnetically connected to the port magnetic securing subsystem to secure the optical connector to the optical port; and
a mechanical release device that is coupled to the optical connector and that is configured to mechanically disconnect the connector magnetic securing subsystem from the port magnetic securing subsystem to release the optical connector from the optical port.

8. The IHS of claim 7, wherein the connector magnetic securing subsystem includes a plurality of neodymium magnets.

9. The IHS of claim 7, wherein the optical connector includes an optical conduit subsystem, and wherein the mechanical release device is located adjacent the optical conduit subsystem when in a securing orientation while the optical connector is secured to the optical port, and includes a moveable connection to the optical connector that configures the mechanical release device to move relative to the optical connector and into a release orientation in which the mechanical release device extends from the optical connector and into engagement with the optical port to release the optical connector from the optical port.

10. The IHS of claim 7, wherein the connector magnetic securing subsystem includes a plurality of connector magnets that are configured to magnetically interact with the port magnetic securing subsystem to align the optical connector with the optical port when the optical connector is moved adjacent the optical port.

11. The IHS of claim 10, wherein the port magnetic securing subsystem includes respective ferromagnetic elements for each of the plurality of connector magnets.

12. The IHS of claim 11, wherein a portion of the chassis adjacent port magnetic securing subsystem is provided by a non-ferromagnetic material.

13. The IHS of claim 7, wherein the connector magnetic subsystem includes a plurality of connector magnets that are configured to magnetically interact with corresponding port magnets included in the port magnetic securing subsystem to align and connect the optical connector with the optical port when the optical connector is moved adjacent the optical port while oriented with the optical port, and that are configured to magnetically interact with the corresponding port magnets included in the port magnetic securing subsystem to prevent connection of the optical connector with the optical port when the optical connector is moved adjacent the optical port while misoriented with the optical port.

14. A method for magnetically securing and releasing an optical connector to and from an optical port, comprising:
moving, by an optical connector that is included on an optical cable, adjacent an optical port;
magnetically connecting, by a connector magnetic securing subsystem that is included on the optical connector, to a port magnetic securing subsystem on the optical port to secure the optical connector to the optical port; and
mechanically disconnecting, by a mechanical release device that is coupled to the optical connector, the connector magnetic securing subsystem from the port magnetic securing subsystem to release the optical connector from the optical port.

15. The method of claim 14, wherein the connector magnetic securing subsystem includes a plurality of neodymium magnets.

16. The method of claim 14, further comprising:
moving, by the mechanical release device from a securing orientation that is adjacent an optical conduit subsystem on the optical connector while the optical connector is secured to the optical port, relative to the optical connector and into a release orientation in which the mechanical release device extends from the optical connector and into engagement with the optical port to release the optical connector from the optical port.

17. The method of claim 14, further comprising:
magnetically interacting, by a plurality of connector magnets included on the connector magnetic securing subsystem, with the port magnetic securing subsystem to align the optical connector with the optical port when the optical connector is moved adjacent the optical port.

18. The method of claim 17, wherein the port magnetic securing subsystem includes respective ferromagnetic elements for each of the plurality of connector magnets.

19. The method of claim 18, wherein the optical port is included on a chassis, and wherein a portion of the chassis adjacent port magnetic securing subsystem is provided by a non-ferromagnetic material.

20. The method of claim 14, further comprising:
magnetically preventing, by a plurality of connector magnets included in the connector magnetic securing subsystem via magnetic interaction with corresponding port magnets included in the port magnetic securing subsystem, connection of the optical connector with the optical port when the optical connector is moved adjacent the optical port while misoriented with the optical port; and
magnetically connecting, by the plurality of connector magnets via magnetic interaction with the corresponding port magnets, the optical connector with the optical port when the optical connector is moved adjacent the optical port while oriented with the optical port.
